(19) United States
(12) Patent Application Publication
(10) Pub. No.: US 2005/0162091 A1
(43) Pub. Date: Jul. 28, 2005

(54) Electric incandescent lamp

(75) Inventors: Christian Seichter, Herbrechtingen (DE); Klaus Wittmann, Sontheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/034,883

(22) Filed: Jan. 14, 2005

(30) Foreign Application Priority Data
Jan. 22, 2004 (DE) 102004004017.6

(51) Int. Cl. B60Q 1/00

(52) U.S. Cl. 315/60; 315/77; 315/56

(57) ABSTRACT

The invention relates to an electric incandescent lamp, in particular a vehicle headlight lamp having at least one incandescent filament arranged within a lamp vessel and power supply lines for the incandescent filament, at least one power supply line having a bent-back end, which is connected to an outgoing filament line, which extends transversely to the winding axis of the at least one incandescent filament, of the at least one incandescent filament. According to the invention, the bent-back end of the power supply line and the outgoing filament line of the at least one incandescent filament are arranged on a plane transverse to the winding axis of the at least one incandescent filament, in order to be able to compensate for so-called over- or under-winding during the manufacturing process of the at least one incandescent filament.

### I. TECHNICAL FIELD

The invention relates to an electric incandescent lamp having at least one incandescent filament (63) arranged within a lamp vessel (60) and power supply lines (64, 65) for the incandescent filament (63), at least one of the power supply lines (65) having a bent-back end (651), which is connected to an outgoing filament line (632), which extends transversely to the winding axis of the at least one incandescent filament (63), of the at least one incandescent filament.

### II. BACKGROUND ART

Such an incandescent lamp is disclosed in the laid-open specification DE 101 45 427 A1. This specification describes a halogen incandescent lamp for a vehicle headlight, which has two incandescent filaments enclosed in a lamp vessel for the purpose of producing the lower beam or upper beam. The main filament serving the purpose of producing the upper beam is aligned transversely to the lamp axis, and its outgoing filament lines, which are surrounded by a molybdenum film, are each welded to a power supply wire. The auxiliary filament, which serves the purpose of producing the lower beam, is aligned axially in the lamp vessel and has an outgoing filament line, which extends transversely to its winding axis, is surrounded by a molybdenum film, and is welded to the end of a power supply wire. The other outgoing filament line of this incandescent filament is welded to an antidazzle device which is produced from a molybdenum sheet.

One disadvantage of the above-described filament suspension of the auxiliary filament consists in the fact that inaccuracies when winding the incandescent filament can lead to mechanical stresses in the incandescent filament and even to torsion of the incandescent filament. For example, if during the winding process of the auxiliary filament a quarter-turn too much or too little is produced, at least one of the outgoing filament lines of the auxiliary filament points in the incorrect direction and then cannot be welded to the power supply line without deforming the incandescent filament or the outgoing filament line.

### III. DISCLOSURE OF THE INVENTION

The object of the invention is to provide an electric incandescent lamp having improved filament suspension. In particular, despite any inaccuracies in the winding of the incandescent filament, it should be possible to fix the incandescent filament to the power supply lines without causing mechanical stresses in the incandescent filament.

This object is achieved according to the invention by an electric incandescent lamp having at least one incandescent filament arranged within a lamp vessel and power supply lines for the incandescent filament, at least one of the power supply lines having a bent-back end, which is connected to an outgoing filament line, which extends transversely to the winding axis of the at least one incandescent filament, of the at least one incandescent filament, wherein said bent-back end and the outgoing filament line of said at least one incandescent filament are arranged on a plane transverse to the winding axis of the at least one incandescent filament. Particularly advantageous embodiments of the invention are described in the dependent patent claims.

The electric incandescent lamp according to the invention has at least one incandescent filament arranged within a lamp vessel and power supply lines for this incandescent filament, at least one of the power supply lines having a bent-back end, which is connected to an outgoing filament line, which extends transversely to the winding axis of the at least one incandescent filament, of the at least one incandescent filament, and this bent-back end and the above-mentioned outgoing filament line being arranged on a plane transverse to the winding axis of the at least one incandescent filament.

This ensures that the outgoing filament line, which is to be connected to the bent-back end of the power supply line, of the at least one incandescent filament can be connected to the power supply line without mechanical stresses being brought about in the incandescent filament even in the case of inaccuracies when winding the incandescent filament. If the incandescent filament, owing to manufacturing tolerances during the winding process, has a fraction of a turn too much or too little, the angle between the outgoing filament line of the incandescent filament and the bent-back end of the power supply line is altered, as a result of which the connection point between the outgoing filament line and the power supply line on the bent-back end of the power supply line is correspondingly offset. If, for example, the incandescent filament depicted in FIG. 1 has a fraction of a winding too little, the connection point between the outgoing filament line and the bent-back end of the power supply line migrates in the direction of the end face of the bent-back end, when the other outgoing filament line of the incandescent filament is considered to be physically fixed.

Correspondingly, the connection point between the outgoing filament line and the bent-back end of the power supply line on the bent-back end migrates in the opposite direction when the incandescent filament has a fraction of a turn too much. The filament suspension according to the invention thus makes it possible in the abovementioned cases to reliably fix the incandescent filament to its power supply lines without bringing about mechanical stresses in the incandescent filament.

The length of the bent-back end of the power supply line is preferably a value in the range from approximately 1 mm to 5 mm. As a result, all of the manufacturing tolerances which are conventionally brought about during the winding process of the incandescent filament can be taken into account. According to the preferred exemplary embodiments of the invention, the bent-back end of the power supply line and the outgoing filament line associated therewith of the at least one incandescent filament are preferably arranged on a plane perpendicular to the winding axis of the abovementioned incandescent filament. As a result, it is possible to prevent kinks or bends in the outgoing filament line.

The power supply line equipped with the above-mentioned bent-back end is preferably in the form of a wire for manufacturing-related reasons. The bent-back end of the power supply line may be flattened, in order to make possible an effective welded joint to the outgoing filament line of the at least one incandescent filament. The abovementioned outgoing filament line may also be surrounded by a molybdenum film, in order to ensure an effective welded joint between the incandescent filament and the preferably molybdenum power supply line.

### IV. BRIEF DESCRIPTION OF THE DRAWINGS

The invention will be explained in more detail with reference to two preferred exemplary embodiments. In the drawing:

FIG. 1 shows a side view of a filament suspension for an electric incandescent lamp according to the first exemplary embodiment of the invention,

FIG. 2 shows a first side view of a filament suspension for an electric incandescent lamp according to the second exemplary embodiment of the invention,

FIG. 3 shows a second side view of the filament suspension depicted in FIG. 2 in a view rotated through 90 degrees,

FIG. 4 shows a plan view of the filament suspension depicted in FIGS. 2 and 3,

FIG. 5 shows a side view of a halogen incandescent lamp, which can be equipped with the filament suspension depicted in FIGS. 2 to 3, and

FIG. 6 shows a side view of a halogen incandescent lamp according to the first exemplary embodiment of the invention, which can be equipped with the filament suspension depicted in FIG. 1.

### V. BEST MODE FOR CARRYING OUT THE INVENTION

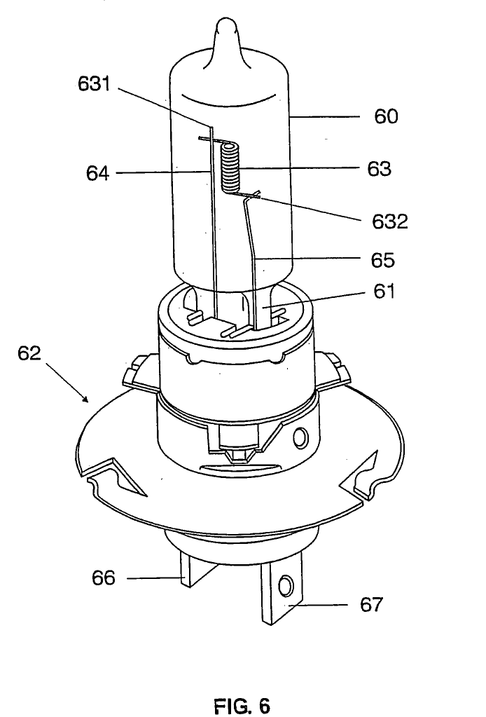

FIG. 6 shows a schematic illustration of an electric incandescent lamp according to the first exemplary embodiment of the invention. This incandescent lamp is a so-called single-filament halogen incandescent lamp, which is equipped with an incandescent filament and is envisaged for a motor vehicle headlight. This halogen incandescent lamp has a vitreous lamp vessel 60, which is sealed by means of a pinch foot 61. The pinch foot 61 is fixed in a base 62. An incandescent filament 63 which is produced from tungsten wire is arranged in the interior of the essentially cylindrical lamp vessel 60 and is aligned parallel to the lamp vessel axis. The incandescent filament 63 has two outgoing filament lines 631, 632, which extend perpendicularly to its winding axis and are each welded to a molybdenum power supply wire 64, 65. The power supply wires 64, 65 are passed out of the lamp vessel 60 via the pinch foot 61 and are each electrically conductively connected to an electrical connection 66 or 67 of the halogen incandescent lamp.

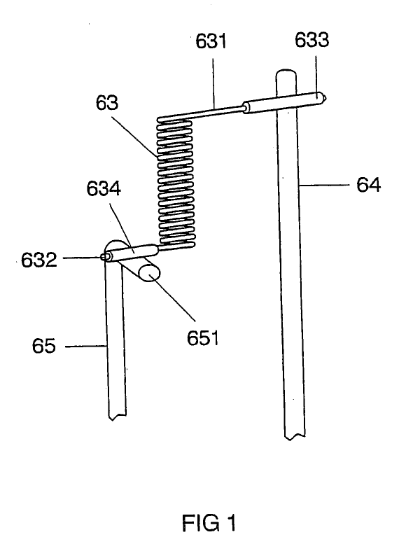

FIG. 1 shows details of the filament suspension of the incandescent filament 63 of the halogen incandescent lamp depicted in FIG. 6. The first outgoing filament line 631 of the incandescent filament 63 has a molybdenum film 633 wound around it and is welded to the power supply wire 64. The second outgoing filament line 632 of the incandescent filament 63 is likewise surrounded by a molybdenum film 634 and is welded to the bent-back end 651 of the power supply wire 65. The bent-back end 651 of the power supply wire 65 and the second outgoing filament line 632 of the incandescent filament 63 are arranged on a common plane perpendicular to the winding axis of the incandescent filament 63.

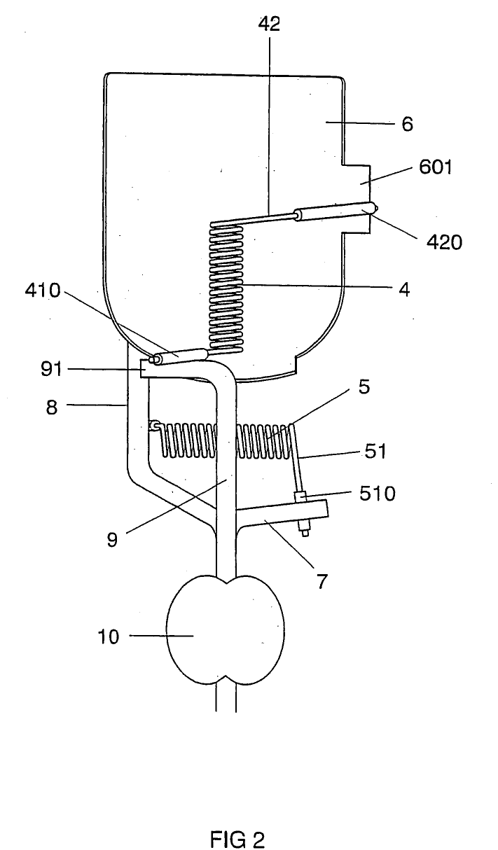

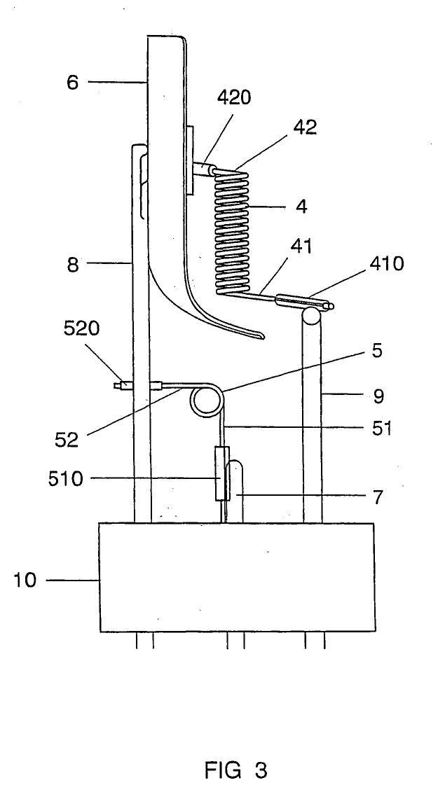

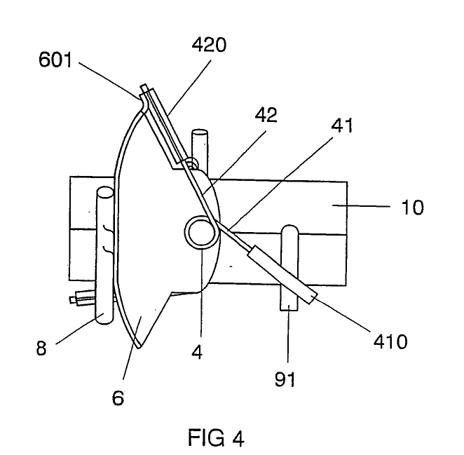

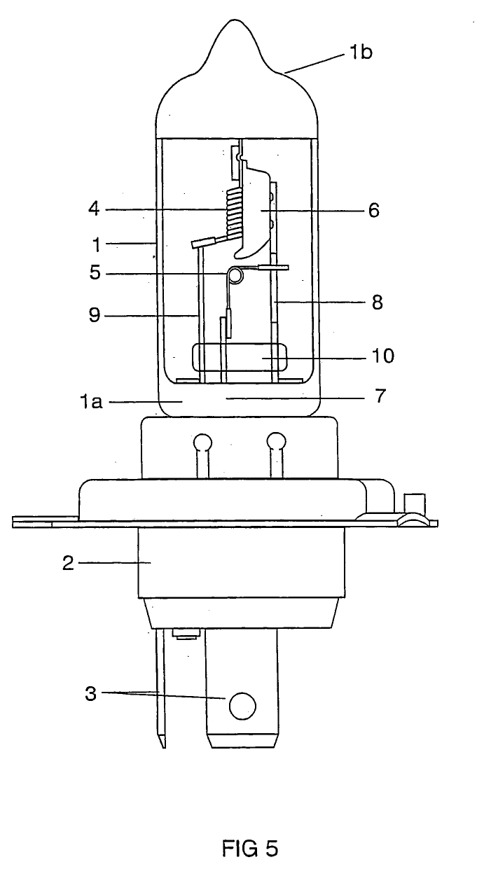

FIGS. 2 to 4 show different views of a filament suspension according to the invention for a so-called two-filament halogen incandescent lamp, which is equipped with two incandescent filaments and is envisaged for a motor vehicle headlight. FIG. 5 shows a schematic illustration of such a halogen incandescent lamp. This halogen incandescent lamp has an essentially cylindrical, vitreous lamp vessel 1, which is sealed in a gas-tight manner by means of a pinch foot 1a. The dome of the lamp vessel 1 is provided with a coating 1b which is impermeable to light. The pinch foot 1a is fixed in the base 2, which is equipped with three electrical connections 3. A first incandescent filament 4 (the so-called auxiliary filament 4), which is aligned axially with respect to the lamp vessel axis, and a second incandescent filament 5 (the so-called main filament 5), which is aligned transversely with respect to the lamp vessel axis, are arranged within the lamp vessel 1. The auxiliary filament 4 is partially surrounded by a shading apparatus 6, which is referred to below as the antidazzle device 6. Said auxiliary filament 4 serves the purpose of producing the lower beam or the daytime driving light in a motor vehicle, whereas the main filament 5 serves the purpose of producing the upper beam. The filament suspension for the two incandescent filaments 4, 5 comprises the antidazzle device 6 and three power supply wires 7, 8 and 9 as well as the quartz glass bar 10, in which the power supply wires 7, 8 and 9 are sealed. These power supply wires 7 to 9 are passed through the pinch foot 1a and are each electrically conductively connected to an electrical connection 3 of the halogen incandescent lamp. The three power supply wires 7 to 9 are fixed by means of the quartz glass bar 10 on a common plane perpendicular to the winding axis of the main filament 5.

Details on the filament suspension of the halogen incandescent lamp depicted in FIG. 5 and according to the second exemplary embodiment of the invention are illustrated in FIGS. 2 to 4. The first outgoing filament line 51, surrounded by a molybdenum film 510, of the main filament 5 is welded to a bent-back end of the first power supply wire 7. The other outgoing filament line 52, surrounded by a molybdenum film 520, of the main filament 5 is welded to the second power supply wire 8, to which the antidazzle device 6 is also fixed by means of a welded joint. The first outgoing filament line 41, surrounded by a molybdenum film 410, of the auxiliary filament 4 extends transversely, in particular perpendicularly, to the winding axis of the auxiliary filament 4 and is welded to the end 91, which is bent back approximately at right angles, of the third power supply wire 9. The bent-back end 91 of the third power supply wire 9 and the first outgoing filament line 41 of the auxiliary filament 4 are arranged on a common plane perpendicular to the winding axis of the auxiliary filament 4. The bent-back end 91 has a length of approximately 3 mm. The second outgoing filament line 42, surrounded by a molybdenum film 420, is welded to a tab 601 which is integrally formed on the antidazzle device 6. As a result, when the auxiliary filament 4 is fixed, any manufacturing tolerances during its winding process can be taken into account, as has already been described in the text above, when, for the purpose of mounting the auxiliary filament 4, first its second outgoing filament line 42 is welded to the tab 601 and then its first outgoing filament line 41 is welded to the bent-back end 91. The position of the welded joint of the outgoing filament line 41 on the bent-back end 91 is then influenced by the accuracy of the abovementioned winding process.

1. An electric incandescent lamp having at least one incandescent filament arranged within a lamp vessel and power supply lines for the incandescent filament, at least one of the power supply lines having a bent-back end, which is connected to an outgoing filament line, which extends transversely to the winding axis of said at least one incandescent filament, of the at least one incandescent filament,
wherein said bent-back end and the outgoing filament line of said at least one incandescent filament are arranged on a plane transverse to the winding axis of the at least one incandescent filament.

2. The electric incandescent lamp as claimed in claim 1, wherein the plane is arranged essentially perpendicular to the winding axis of the at least one incandescent filament.

3. The electric incandescent lamp as claimed in claim 1, wherein the power supply line is in the form of a wire.

4. The electric incandescent lamp as claimed in claim 1, wherein the electric incandescent lamp is a vehicle headlight lamp.
